(19) United States
(12) Patent Application Publication
(10) Pub. No.: US 2010/0030639 A1
(43) Pub. Date: Feb. 4, 2010

(54) Method and Apparatus for Displaying a Plurality of Short Ads in a Single Ad Spot

(76) Inventors: Xin Feng, Basking Ridge, NJ (US); Srinivasa Dharmaji, Cupertino, CA (US)

Correspondence Address: GLENN PATENT GROUP, 3475 EDISON WAY, SUITE L, MENLO PARK, CA, 94025, US

(21) Appl. No.: 12/506,644

(22) Filed: Jul. 21, 2009

Related U.S. Application Data
(60) Provisional application No. 61/137,358, filed on Jul. 30, 2008.

(51) Int. Cl. G06Q 30/00

(52) U.S. Cl. 705/14.43; 705/14.64

(57) ABSTRACT

Available advertisement spot duration is used to display a plurality of advertisements, and to obtain maximum impact while displaying a plurality of advertisements, within an advertisement spot, where the advertisements are each typically of a fixed duration, the sum of which is the total duration of the advertisement spot. Further optimization is accomplished by using advertisements of optimized duration, the advertisements having a cumulative duration of less than that of the advertisement spot, and by using a static advertisement and/or picture as a filler for the rest of the duration. Because static advertisements and/or pictures do not require a minimum duration for impact, they can be used to fill in the time left over from one or multiple advertisements within an advertisement spot. Embodiments of the invention find particular application for displaying advertisements on mobile handheld devices (MHDDs) to improve the impact of the advertisements.

### CROSS REFERENCE TO RELATED APPLICATIONS

This application claims priority to U.S. provisional patent application Ser. No. 61/137,358, dated 30 Jul. 2008, which application is incorporated herein in its entirety by this reference thereto.

### BACKGROUND OF THE INVENTION

1. Technical Field

The invention relates to the efficient rendering and display of multiple video advertisements on mobile handheld devices. More particularly, the invention relates to a method and apparatus for displaying a plurality of short ads in a single ad spot.

2. Description of the Prior Art

One of the problems of displaying video-advertisements (ads) today is that there are fixed time advertisement spots (ad spots) where ads can be displayed. These ad spots are typically of fixed duration. A typical ad spot in a content stream for wired displays is on the order of 30 seconds in duration. When an ad or ads have to be displayed within the ad spot, the ad must be of an exact duration so that time is neither wasted and so that the ad is not cut off at the end. Hence, typical ads today are have a duration of 30 seconds or larger to fit the ad spot, as shown in FIG. 1. This is an artifact of the connected system in which ads have a minimum duration of 30 seconds to fit into the 30-second ad spot. FIG. 1 shows a 30 second ad filling a 30 second ad spot. Hence, the legacy 30 second ads have also been the standard in mobile handheld display devices (MHDDs). With earlier versions of MHDDs two additional limitations existed: 1) lack of processing power; and 2) limited storage capability on the MHDD that limited the ability of the device to store, render, and display multiple 30-second ads. Recent studies have also shown that ads on MHDDs can be effective if shown for shorter time periods. The currently minimum time for effective ad display on MHDD has been shown to have a duration of not less than ten seconds. Hence, this is now considered the absolute minimum time for an effective ad. It has also been shown that some ads should be displayed for more than the minimum duration of 10 seconds for optimum impact.

Research on the display of ads on MHDDs has shown recently that ten seconds is the minimum time that any ad should be shown to be effective. Optimum time for ads can vary and can be higher than the minimum time. Though ten seconds is the absolute minimum as understood today, there is an optimum duration for viewing ads which is most effective. This duration is typically varying and is often not a multiple of five or ten seconds. Showing an ad for a much longer duration tends to reduce the impact due to the viewer getting bored and distracted. Conversely, showing it for a shorter duration reduces the impact due to reduced assimilation. In the past, it has not been possible to provide the optimum window for multiple ad viewing within an ad spot due to the requirement to fill the time slot paid for most efficiently.

It would be advantageous if multiple ads of fixed or optimum impact duration could be shown on an MHDD, where the multiple ads covered the total ad spot duration. It would be further advantageous if ads of varying duration, but falling within the time slot, could be shown without bothering about leaving excess time, paid for, vacant in the ad spot. It would be furthermore advantageous to be able to display multiple ads in any ad spot duration available.

### SUMMARY OF THE INVENTION

In an embodiment of the invention, available advertisement spot duration is used to display a plurality of advertisements, and to obtain maximum impact while displaying a plurality of advertisements, within an advertisement spot. The advertisements are each typically of a fixed duration, the sum of which is the total duration of the advertisement spot. Further optimization is accomplished by using advertisements of optimized duration, the advertisements having a cumulative duration of less than that of the advertisement spot, and by using a static advertisement and/or picture as a filler for the rest of the duration. Because static advertisements and/or pictures do not require a minimum duration for impact, they can be used to fill in the time left over from one or multiple advertisements within an advertisement spot. Embodiments of the invention find particular application for displaying advertisements on mobile handheld devices (MHDDs) to improve the impact of the advertisements.

### BRIEF DESCRIPTION OF THE DRAWINGS

FIG. 1 is a schematic diagram of a time line showing a typical ad of fixed time of 30 seconds being shown within an ad spot having a duration of 30 seconds (prior art);

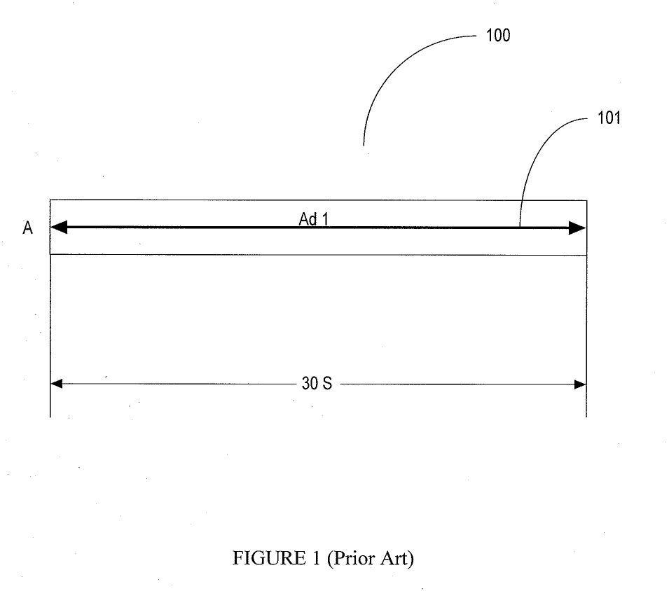

FIG. 2 is a schematic diagram of a time line showing a typical division of time for multiple fixed time ads covering a 30 second ad spot according to the invention;

FIG. 3 is a schematic diagram of a time line showing a typical division of time for multiple fixed size advertisements in an ad spot of any duration according to the invention;

FIG. 4 is a schematic diagram of a time line showing a typical division of time for multiple optimized advertisements in a 30-second ad spot with a picture filler ad according to the invention;

FIG. 5 is a schematic diagram of a time line showing a typical division of time for multiple optimized advertisements in an ad spot of any duration with a picture filler ad according to the invention; and

FIG. 6 is a block schematic diagram of an exemplary system for transferring a plurality of ads and a static advertisement/picture from an ad caster to a mobile handheld display device for storage according to the invention.

### DETAILED DESCRIPTION OF THE INVENTION

An embodiment of the invention uses available advertisement spot duration to display multiple advertisements and to obtain maximum impact while displaying multiple advertisements within the advertisement spot. Typically, such advertisements are of a fixed duration, where the sum of all advertisements shown during the advertisement spot is the total duration of the advertisement spot. Further optimization is accomplished by using a plurality of advertisements of optimized duration having a cumulative duration less than that of the advertisement spot, and using a static advertisement and/or picture as a filler for the rest of the advertisement spot duration. Because static advertisements and/or pictures do not require a minimum duration for impact, they can be used to fill in the time left over from one or multiple advertisements. These methods are of particular application for advertisements displayed on mobile handheld devices (MHDDs) in providing an improved impact of the advertisements.

In the past, it has not been possible to show multiple ads within the minimum 30 second ad spot on an MHDD because an MHDD could not render and display multiple ads. Limitations of bandwidth availability, storage, and rendering capability on the MHDDs also limited the use of multiple ads within an ad spot. For this reason, ad duration could not be optimized for best results. The need for filling in the fixed ad spot duration, typically 30 seconds, drove the creation of ads for MHDDs that used up the full 30-second ad spot.

It has also not been possible to use any extra time if it became available in the ad spot.

Increased processing power and storage availability on MHDDs have reduced the impact of the two limitations that existed for rendering multiple ads on MHDDs. Generic method for generating, downloading, rendering, and inserting ads is known, for example, in the U.S. provisional patent application entitled Targeted Advertisement Transmission and Delivery in a Bandwidth Limited Multicast Wireless System, Ser. No. 60/960,330, filed 25 Sep. 2007, and in the U.S. provisional patent application entitled Generation and Transmission of an Addressable Spot Guide for Alternate Content Insertion in Multicast Wireless Transmission, Ser. No. 12/331,316, filed on 10 Dec. 2007, each of which is assigned to common assignee, and each of which is incorporated herein in its entirety by this reference thereto.

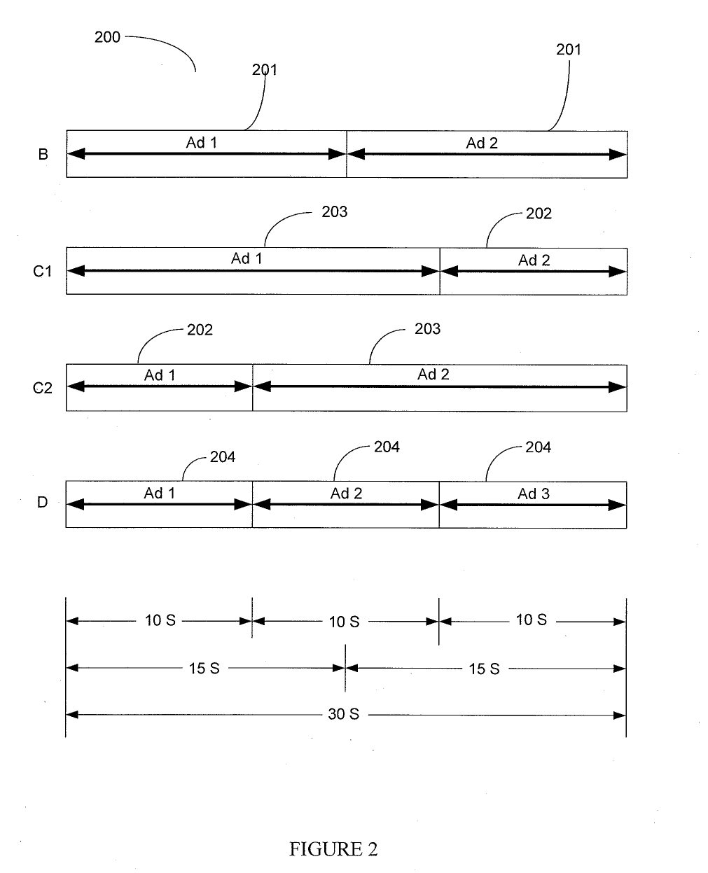

An embodiment of the invention makes it possible to download, render, and display multiple short effective ads of any duration. This allows a 30-second ad spot to have a plurality of ads presented to a viewer during the ad spot. Each ad, depending on the ad's content, has an optimum time duration when the impact is greatest. With the invention, an ad can be displayed for a time equal to or above this optimum, even with fixed ad timing. An embodiment of the invention allows multiple ads to be displayed for durations close to their optimum time by rendering and displaying a fixed duration ad on an MHDD, as shown in FIG. 2. The 30-second time slot 200 is divided into two or three fixed time slots that are multiples of five seconds each to enable fixed size ad generation. The three combinations that use the minimum requirement for ad impact of ten seconds within a 30-second ad spot duration with exact partitions having multiples of five seconds for full ad spot coverage are:
1) Two 15-second ads 201 within the 30-second time slot

[2×T₁₅=30 seconds]; (1)
2) One 20-second ad 203 and one 10-second ad 202 within the 30-second time slot

[T₂₀+T₁₀ or T₁₀+T₂₀=30 seconds]; and (2)
3) Three 10-second ads 204 within the 30-second time slot

[3×T₁₀=30 seconds]. (3)

The above is shown in FIG. 2 for a 30-second ad spot having the following fixed ad combinations: The 30-second ad spot is divided into two 15-second ad display units 201; into a 10-second and a 20-second ad unit 202 and 203; or into three 10-second ad display units 204 to fill in the total time.

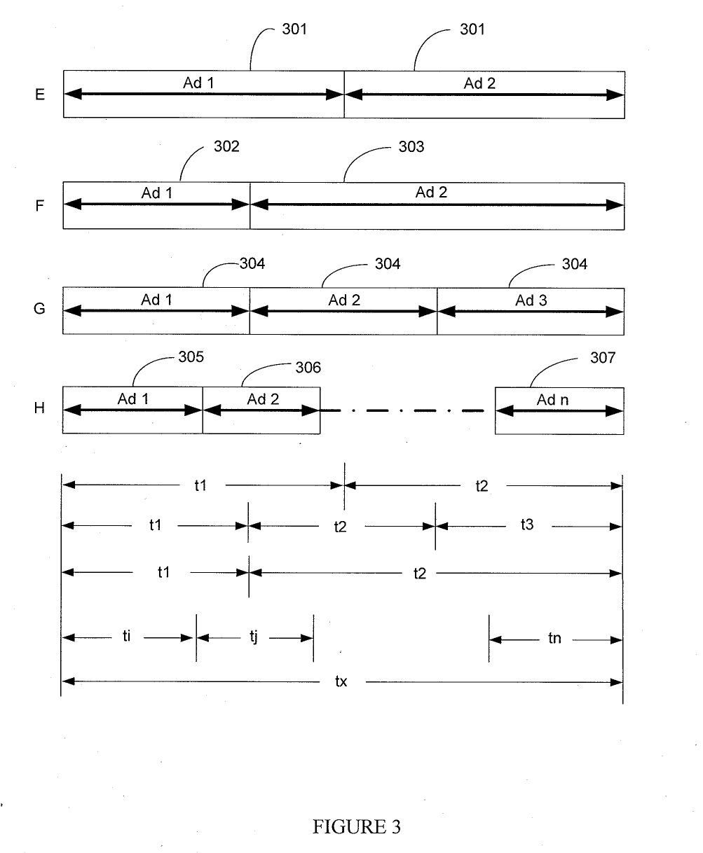

The use of multiple ads having a fixed timing to fill an ad spot of any duration of tx seconds is shown in FIG. 3. These fixed ads use multiples of a fixed time duration, typically ‘y’ seconds, but have a minimum ad duration, typically of ten seconds or more. These ads are used to fill any ad spot available. FIG. 3 shows two equal ads 301 filling the ad spot, two unequal ads 302 and 303 filling the ad spot, three ads of equal duration 304 similar to FIG. 2, and a set of multiple ads of fixed duration 305, 306, and 307 within the total duration tx of the ad spot. The multiple fixed ads, 305, 306, 307 etc. have durations t1, t2, . . . tn that are used to fill the ad spot of duration tx.

In the generic example:

t1+t2+ . . . +tn=Σti=tx (4)

where:
a) tx=total duration of ad spot;
b) i=1 to n;
c) ti is a multiple of duration y; and
d) ti>min effective duration, typically 10-seconds.

Even though a typical 10-second ad has the minimum duration to be effective, the optimum time for any ad can vary and can be higher than the minimum time. For each ad based on the content there is an optimum, most effective duration for viewing. This duration typically varies from ad to ad, and is often not a multiple of five seconds or the duration value ‘y’ used in fixed ads. Showing an ad for a much longer duration tends to reduce the impact of the ad due to the viewer getting bored and distracted, and showing an ad for a shorter duration reduces the impact due to reduced assimilation of the ad's content by the viewer.

In the past, it has not been possible to provide the optimum window for the viewing of multiple ads within an ad spot due to the requirement to fill the time slot paid for most efficiently. An embodiment of the invention allows ads to be displayed for their optimum duration within an ad spot while avoiding the waste of a portion of a paid for, premium advertisement spot.

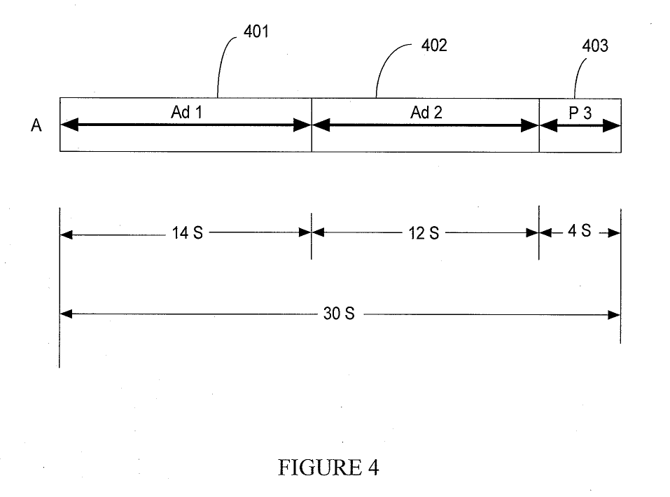

FIG. 4 shows two ads being displayed for their optimum duration: the first ad 401 being displayed for 14 seconds and the second ad 402 being displayed for 12 seconds in a 30-second ad spot. This results in a currently unusable time of four seconds when there is nothing for the display to show to the viewer. This is unacceptable because the cost of wasted time within an ad spot is very high. To improve the ad time use, a static ad or picture 403 is inserted into the advertisement spot instead of another ad. This is done for the unfilled advertisement spot duration of four seconds that is otherwise available after the scheduled ads have been displayed. A picture has a lower impact, but it typically has no minimum or maximum duration for impact. Thus, a picture can be used as a time filler after two or more optimized ads have been displayed. If a longer ad spot is available multiple optimized ads can be shown with the picture as a time filler for a duration less than the minimum time for ad impact. The picture may be shown before, in-between, or after the portion of the advertisement spot in which the scheduled ads are shown.

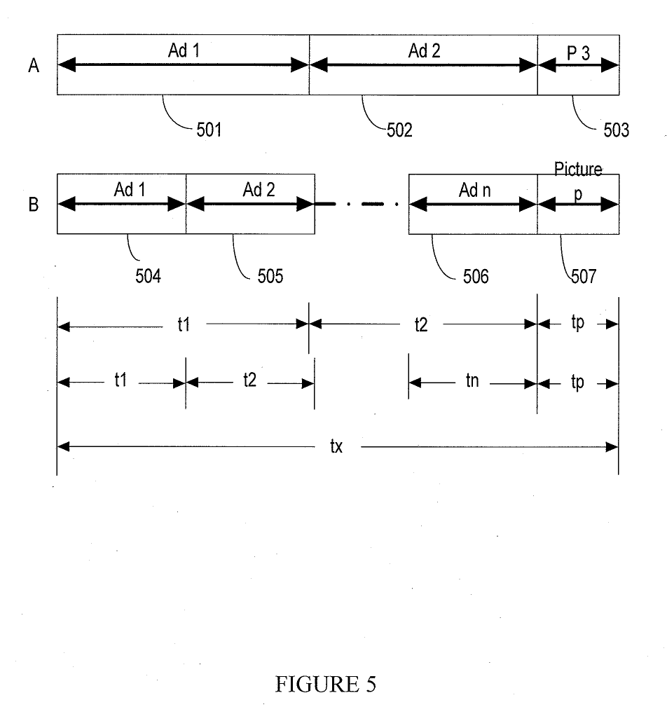

In the embodiment of FIG. 5, two optimized ads 501 and 502 are displayed, and a picture ad 503 is provided to fill any duration tx of the ad spot. This can be extended to so that ads 1 to n having optimized durations of t1 504, t2 505, . . . tn 506 within the ad spot, where the balance of the ad spot is filled with a picture 507, as shown in the generic case.

The generic multiple optimized example:

t1+t2+t3+ . . . +tn+tp=Σti+tp=tx (5)

where:
a) tx=total duration of the ad spot;
b) t1 to tn are ads;
c) ti=optimum duration, typically >10 seconds;
d) i=1 to n;
e) tp is a static ad or picture; and
f) tp<minimum effective duration for a video ad.

This use of a picture to fill in the paid for space once the video ads have been optimized for impact helps provide best results from the video ads while avoiding the waste of paid for ad time. The insertion of a picture ad also helps to use any extra time that unexpectedly becomes available within an ad spot.

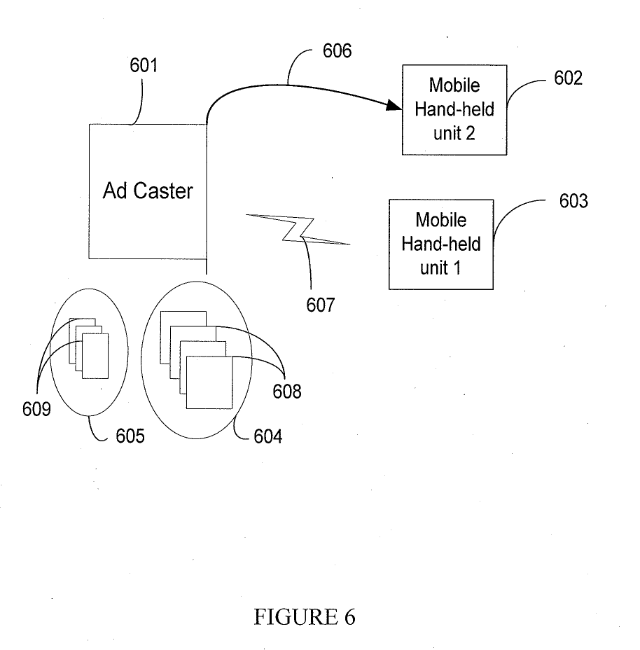

FIG. 6 is a block schematic diagram that shows a system for ad delivery in accordance with the invention herein. The download of ads 608 and, where necessary, static advertisements and/or pictures 609 can be accomplished using standard techniques. The ads 608 to be downloaded are stored in an ad storage 604; the static advertisements and/or pictures 609 are stored in a storage 605, each of which is coupled to an ad caster 601. The ads are downloaded from the ad caster 601 prior to the arrival of the ad spot into MHDDs 602 and 603, e.g. cell phones or PDAs, using any available means, such as wired means 606 or wireless 607 means. The ad caster 601 schedules and helps to download the necessary and correct ads 608 and static advertisements and/or pictures 609 to the MHDDs 602 and 603 when wireless 607 slack time is available or when the MHDDs 602 and 603 are connected to the network by wire 606. The downloaded ads 608 and static advertisements and/or pictures 609 are stored on the MHDDs 602 and 603 prior to the arrival time of the ad spot. When the ads are rendered for viewing in an available ad spot, the optimized ads selected mostly fill the ad spot; any time left is filled by inserting the static advertisements and/or pictures into the ad spot at that time. The use of static advertisements and/or pictures as a filler prevents the unnecessary loss of paid for ad spot time when showing optimized ads, where the total duration of the ads does not completely match the duration of the ad spot.

The static advertisements and/or pictures can also be used as a filler for ad spots that are not a multiple of the minimum duration when fixed duration ads are being used. For example, if an ad spot of 32 seconds become available for use instead of 30 seconds, as required in any of the examples shown in FIG. 2, where fixed ads of total duration of 30 seconds are used, the unused two seconds can be filled with the static advertisements and/or pictures.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A method for displaying multiple fixed duration video advertisements on a mobile handheld display device (MHDD) within an advertisement spot having a fixed duration, comprising the steps of:
dividing the advertisement spot into a plurality of time units, wherein each of said time units has a duration that is a multiple of a first minimum duration; and
displaying a plurality of separate advertisements in said advertisement spot during said time units, wherein each advertisement is displayed for a second minimum duration that is sufficient for each of said separate advertisements to have an impact on a viewer;
wherein a sum of said plurality of time units is equal to the fixed duration of said advertisement spot.

2. The method of claim 1, said fixed advertisement spot has a duration of 30 seconds.

3. The method in claim 2, wherein said first minimum duration is five seconds.

4. The method in claim 2, wherein said second minimum duration is ten seconds.

5. The method of claim 2, wherein each of three of said time units is used for a separate video advertisement, each time unit being equal to ten seconds each.

6. The method of claim 2, wherein each of two of said time units is used for a separate video advertisement, each time unit being equal to fifteen seconds each.

7. The method of claim 1, wherein the fixed duration of said advertisement spot is split into two unequal time units.

8. The method of claim 7, wherein said two unequal time unit are split into a first time unit of ten seconds and a second time unit of twenty seconds.

9. A method for displaying multiple fixed duration video advertisements on a mobile handheld display device (MHDD) within an advertisement spot having a fixed duration, comprising the steps of:
dividing said advertisement spot of fixed duration into multiple time units, wherein each of said time units has a duration that is a multiple of a first minimum duration; and
displaying a separate video advertisement in each of said time units;
wherein each video advertisement is displayed for a second minimum duration that is sufficient for each of said video advertisement to have an impact on a viewer; and
wherein a sum of duration of all said video advertisements in said advertisement spot is equal to the fixed duration of said advertisement spot.

10. A method for displaying multiple optimized duration video advertisements on a mobile hand-held display device (MHDD) within an advertisement spot of fixed duration, comprising the steps of:
identifying an optimum duration for each video advertisement of a set of chosen video advertisements to be displayed;
choosing a plurality of video advertisements for display on said MHDD during said advertisement spot;
ensuring that a total duration of all said chosen video advertisements to be displayed is less than the fixed duration of the advertisement spot;
determining if there is a balance of the fixed duration of said advertisement spot and, if so, if said balance is less than the optimum duration for a video advertisement;
dividing said advertisement spot into multiple time units, each having an optimized duration corresponding to one of said chosen video advertisements to be displayed;
inserting said chosen video advertisements into said corresponding time units having said optimized duration for said chosen video advertisements;
inserting a static advertisement and/or picture into said balance of said fixed duration as a filler, wherein said picture is displayed for said balance of said fixed duration of said advertisement spot;
wherein each said chosen video advertisement is displayed for said optimum duration to achieve maximum viewer impact on said MHDD;
wherein said balance of said fixed duration is used to display said static advertisement and/or picture within said advertisement spot; and
wherein all of said fixed duration of said advertisement spot is used.

11. An apparatus for downloading multiple advertisements to at least one mobile hand held display unit (MHDD), comprising:
an ad caster;
a video advertisement store linked to said ad caster;
a static advertisement and/or picture store linked to said ad caster;
wireless means for connecting said ad caster to said MHDD; and
said ad caster configured for selectively choosing and downloading video advertisements from said video store and static advertisements and/or pictures from said static advertisement and/or picture store to said MHDD via said wireless means when said wireless means are enabled.

12. The apparatus of claim 11, further comprising:
wire means for connecting said ad caster to said MHDD; and
said ad caster configured for selectively choosing and downloading said video advertisements from said video store and said static advertisements and/or pictures from said static advertisement and/or picture store to said MHDD via said wire means when said wire means are enabled.
